(19) United States
(12) Patent Application Publication
(10) Pub. No.: US 2006/0168882 A1
(43) Pub. Date: Aug. 3, 2006

(54) Method and apparatus for culturing plant

(75) Inventors: Masaki Hashimoto, Osaka (JP); Katsuro Miyagawa, Osaka (JP); Kyoko Takeguchi, Osaka (JP)

Correspondence Address: FULBRIGHT & JAWORSKI, LLP, 666 FIFTH AVE, NEW YORK, NY, 10103-3198, US

(73) Assignee: Suntory Flowers Limited

(21) Appl. No.: 11/046,464

(22) Filed: Jan. 28, 2005

(51) Int. Cl. A01G 31/00

(52) U.S. Cl. 47/64

(57) ABSTRACT

[Summary]

[Object] to provide a plant culturing apparatus and method which reduce the operating noise, allow liquid feeding and discharging as well as aeration within a culture vessel, thus facilitating culturing of a plant.

[Solution] The plant culturing apparatus comprises: a transport unit 3 capable of transporting a fluid W between a culture vessel P for culturing a plant G and a reservoir T capable of reserving therein the fluid W to be fed to the plant G through a feed/discharge tube 2 connected and communicated with the transport unit 3 via a tube pump 1; and a direction switching unit 6 capable of switching a transporting direction of the fluid W by the transporting unit 3 between a direction for feeding the fluid W from the reservoir T to the culture vessel P and the opposite direction for discharging the fluid W from the culture vessel P to the reservoir T.

### DETAILED DESCRIPTION OF THE INVENTION

1. Technical Field of the Invention

The present invention relates to an apparatus and a method for culturing a plant.

2. Prior Art

For growth of a plant, in addition to appropriate light and temperature, water, nutriment and air are essential. Regarding water and nutriment, in particular, these need to be fed to the plant according to its growth and the ambient temperature. In the horticulture for enjoyment of plant growth, if one cannot feed or forgets to feed water to the plant during a trip or leave from the house, or to feed fertilizer appropriately thereto, plant growth may fail.

In order to alleviate the trouble of feeding water and nutrient and to prevent forgetting of watering, there has been proposed an automatic watering apparatus utilizing capillary phenomenon, water pressure of tap water, electric pump etc. (see e.g. Japanese Patent Application “Kokai” No. 2000-300092, Japanese Patent Application “Kokai” No. 11-299373 and Japanese Patent Application “Kokai” No. 10-033074). These conventional apparatuses, however, have suffered such problems of watering excessively to the plant rhizosphere to cause root rot, causing growth failure since the apparatuses do not allow mixing of fertilizer in the water to be fed to the plant. Another problem of these conventional apparatuses is that it is difficult to use them indoors since the water fed therefrom tend to leak to the outside of the apparatuses. Above all, no conventional apparatus designed for domestic use has solved these problems.

Namely, for agricultural use or commercial use, there has been proposed an apparatus capable, by utilizing the operational principle of a vacuum pump or a siphon, of forcibly discharging water from inside a plant pot after its feeding in order to prevent excessive watering of plant rhizosphere (e.g. Japanese Patent Application “Kokai” No. 05-284865, Japanese Patent Application “Kokai” No. 2000-4696, Japanese Patent Application “Kokai” No. 2000-61360, Japanese Patent Application “Kokai” No. 2000-312539, Japanese Patent Application “Kokai” No. 2000-324964). There has been also invented an apparatus utilizing a non-contact pump using a chemical resistant pump or air pressure so as to be able to feed a nutrient liquid containing a fertilizer component (e.g. Japanese Patent Application “Kokai” No. 7-25930). Further, there has been also proposed an apparatus capable of collecting nutrient solution by utilizing the gravity for preventing leakage thereof to the outside (Japanese Patent Application “Kokai” No. 2000-224933).

[Problem to be Solved by Invention]

However, the automatic watering apparatuses proposed so far use two pumps such as a liquid feeding pump or compressor and a liquid discharging pump. This construction requires two separate pipes for liquid feeding and liquid discharging. Hence, the construction of the apparatus tends to be complicated. In an attempt to overcome this problem, the prior art has further proposed an apparatus utilizing a vacuum pump having a compressor function, hence being capable of providing both liquid feeding and liquid discharging functions. On the other hand, this apparatus requires such additional components as a switch valve, pressure-resistant tank. In this way, all of the conventionally proposed apparatuses are physically large and complicated in their constructions. Hence, these apparatuses are not suitable for an application such as domestic application where convenience and readiness of maintenance are required. Also, the apparatus using a vacuum pump generates a large operating noise, hence, not suitable for use in a quiet environment such as in a house.

In view of the above-described state of the art, a primary object of the present invention is to provide a plant culturing apparatus and method which reduce the operating noise, allow liquid feeding and discharging as well as venting within a culture vessel, thus facilitating culturing of a plant.

[Solution]

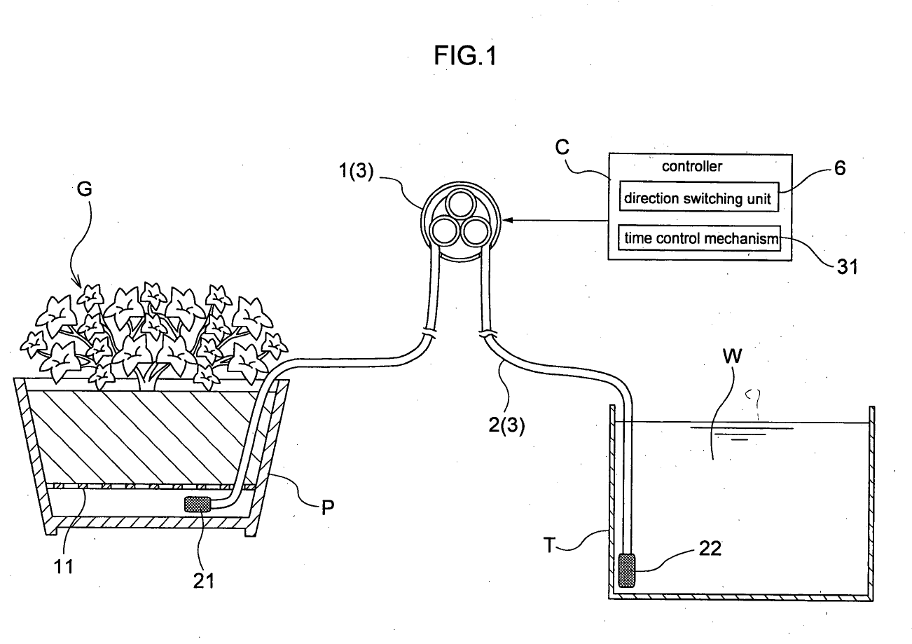

According to the first characterizing feature of a plant culturing apparatus relating to the present invention, as exemplarily illustrated in FIGS. 1-5, the plant culturing apparatus comprises:

a transport unit 3 capable of transporting a fluid W between a culture vessel P for culturing a plant G and a reservoir T capable of reserving therein the fluid W to be fed to the plant G through a feed/discharge tube 2 connected and communicated with the transport unit 3 via a tube pump 1; and

a direction switching unit 6 capable of switching a transporting direction of the fluid W by the transporting unit 3 between a direction for feeding the fluid W from the reservoir T to the culture vessel P and the opposite direction for discharging the fluid W from the culture vessel P to the reservoir T.

[Function/Effect]

With the plant culturing apparatus having the above-described feature, when the direction switching unit switches over a transporting direction of the fluid e.g. to the direction for feeding the fluid from the reservoir to the culture vessel, by operation of the tube pump, the fluid reserved in the reservoir to be fed to the plant can be fed via the feed/discharge tube to the culture vessel for culturing the plant. Conversely, the direction switching unit can switch over the flow direction of the fluid to the direction for discharging the fluid from the culture vessel to the reservoir. In this case, by operation of the tube pump, the fluid and gas or the like can be discharged from the culture vessel to the reservoir via the feed/discharge tube.

Hence, with the transport unit having the above-described construction, the fluid is transported via the feed/discharge tube in association with operation of the tube pump. Therefore, a maintenance operation when needed can be effected mainly on the feed/discharge tube which directly contacts with the fluid to be transported. In this way, the maintenance operation of the transport unit can be easily done. Further, compared with a vacuum pump or a compressor, the tube pump can be formed compact and also the operating vibrations and noise are smaller. Hence, this can be used in such environment as a porch, sun room of a domestic house or inside a room, without disturbing the environment.

Moreover, the transport unit can feed the fluid to a predetermined culture vessel or discharge the fluid and gas or the like therefrom, via the same route, that is, by cycling thereof through the same feed/discharge tube. For this reason, this construction does not require providing separately a feed route for feeding the fluid and nutrient to the plant and a discharge route for discharging them from the plant or providing a tank for reserving the fluid and a pump mechanism for transporting the fluid separately for the feed route and the discharge route. Therefore, the construction of the plant culturing apparatus can be simple. Moreover, as the fluid is transported by such cyclic route, it is also possible to readily grasp e.g. the amount of fluid supplied to the culture vessel by determining the amount of fluid left in the reservoir.

Also, since the direction of the fluid transported by the transport unit can be switched over by the direction switching unit, it is possible to effect aeration to the fluid or liquid (e.g. water, nutrient solution, etc.) reserved in the reservoir by transporting air introduced from the culture vessel to the reservoir via the feed/discharge tube. With this, the amount of oxygen dissolved in the fluid can be increased and a sufficient amount of oxygen can be supplied to the rhizosphere of the plant, thus allowing the plant to grow appropriately.

In this way, the plant can be cultured easily.

According to the second characterizing feature of the plant culturing apparatus relating to the present invention, as exemplarily illustrated in FIGS. 1-5, one terminal end of the feed/discharge tube 2 is connected and communicated with a bottom of the culture vessel P.

[Function/Effect]

With this feature, it is possible to prevent root rot of the plant cultured in the culture vessel and also to promote ventilation inside the culturing medium, thus feeding a sufficient amount of oxygen to the rhizosphere of the plant.

That is, as one terminal end of the feed/discharge tube is connected and communicated with a bottom of the culture vessel, when the fluid is to be fed from the reservoir to the culture vessel, the fluid can be fed in a reliable manner from the end of the feed/discharge tube connected and communicated with the bottom of the culture vessel to the rhizosphere of the plant. In this way, the fluid can be supplied to the plant reliably.

On the other hand, when the fluid is to be discharged from the culture vessel to the reservoir, the fluid inside the culture vessel can be discharged in a reliable manner from the end of the feed/discharge tube connected and communicated with the bottom of the culture vessel, thereby to effectively prevent root rot of the plant being cultured. Also, by introducing fresh air from the outside into the culturing medium in association with the withdrawal of the fluid, the ventilation inside the medium can be promoted. Incidentally, if the suction/discharge operation is continued after completion of discharge of the liquid, further fresh ambient air can be introduced for further promoting the ventilation inside the culturing medium.

Moreover, such ambient air introduced in the medium by the suction/discharge operation from the one end of the feed/discharge tube is transported to the reservoir. With this, in addition to the promotion of ventilation inside the medium, aeration can be provided also to the fluid or liquid reserved in the reservoir, thus increasing the amount of oxygen dissolved therein.

That is to say, it is possible to prevent root rot of the plant cultured in the culture vessel and to promote ventilation inside the culturing medium and increase the concentration of oxygen dissolved in the liquid reserved in the reservoir, so that the plant can be grown appropriately with sufficient oxygen supply to its rhizosphere.

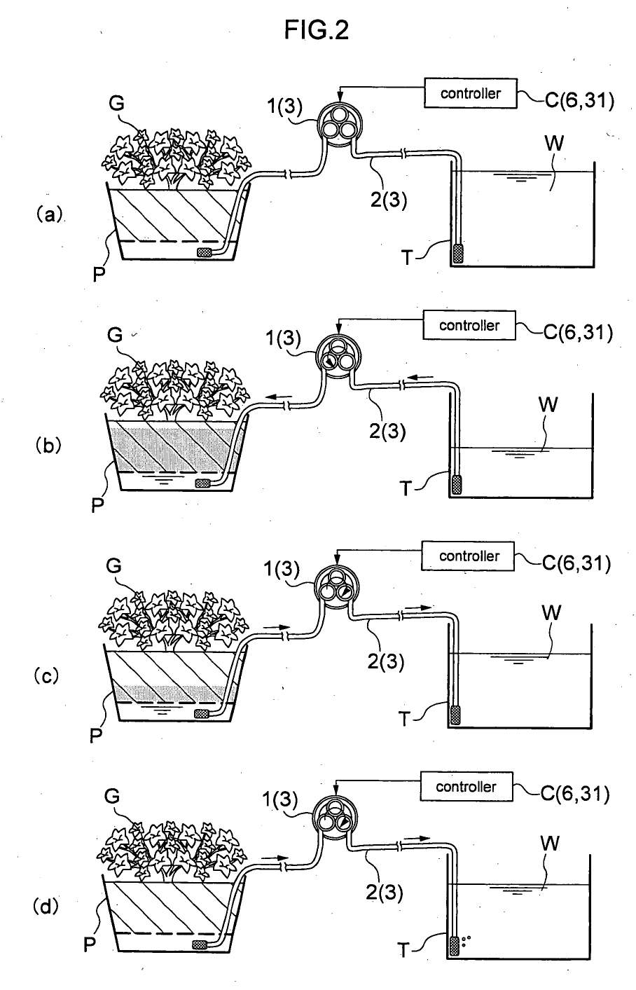

According to the third characterizing feature of the plant culturing apparatus relating to the present invention, as exemplarily illustrated in FIGS. 1 and 2, the apparatus further comprises a control mechanism 31 for terminating the transport of the fluid from the one terminal end of the feed/discharge tube connected and communicated with the bottom of the culture vessel P to the reservoir T after a predetermined amount of the fluid has been transported to the reservoir T.

[Function/Effect]

With this feature, by providing appropriate ventilation to the culturing medium, the plant can be grown in an even more reliable manner.

With the control mechanism described above, the transport of the fluid from the one terminal end of the feed/discharge tube connected and communicated with the bottom of the culture vessel to the reservoir is terminated after a predetermined amount of the fluid has been transported to the reservoir. Hence, when outside air is introduced from the one end of the feed/discharge tube into the culturing medium, appropriate ventilation can be provided to the medium. As a result, it is possible to avoid such inconvenience as excessive ventilation of the medium with outside air, thus inadvertently drying the medium.

That is to say, by controlling the air ventilation amount to the medium through the use of the above feature, appropriate ventilation can be ensured, whereby the plant can be grown even more reliably.

According to the fourth characterizing feature of the plant culturing apparatus relating to the present invention, said control mechanism comprises a time control mechanism for controlling said transport unit according to an operational time period of the transport unit.

[Function/Effect]

With this feature, transport of the fluid by the tube pump is effected according to the time period required for this transport, i.e. according to the operational time period of the transport unit. Hence, the construction of the control mechanism can be simplified and the maintenance operation thereof can be more convenient.

According to the fifth characterizing feature of the plant culturing apparatus relating to the present invention, said operational time period of the transport unit is set longer than a time period within which the transport of the fluid from inside the culture vessel to the reservoir is terminated.

[Function/Effect]

With this feature, the operational time period of the transport unit is set longer than a time period within which the transport of the fluid from inside the culture vessel to the reservoir is terminated. Therefore, the gas such as air can be continuously transported from the culture vessel to the reservoir after the transport of the fluid from inside the culture vessel to the reservoir has been completed. As a result, an appropriate amount of air not resulting in excessive drying of the medium in the culture vessel can be caused to pass this medium to supply oxygen to the rhizosphere of the plant. Further, when the air passing through the vessel reaches the reservoir, this provides aeration to the fluid reserved therein, thus increasing the concentration of oxygen dissolved in the fluid.

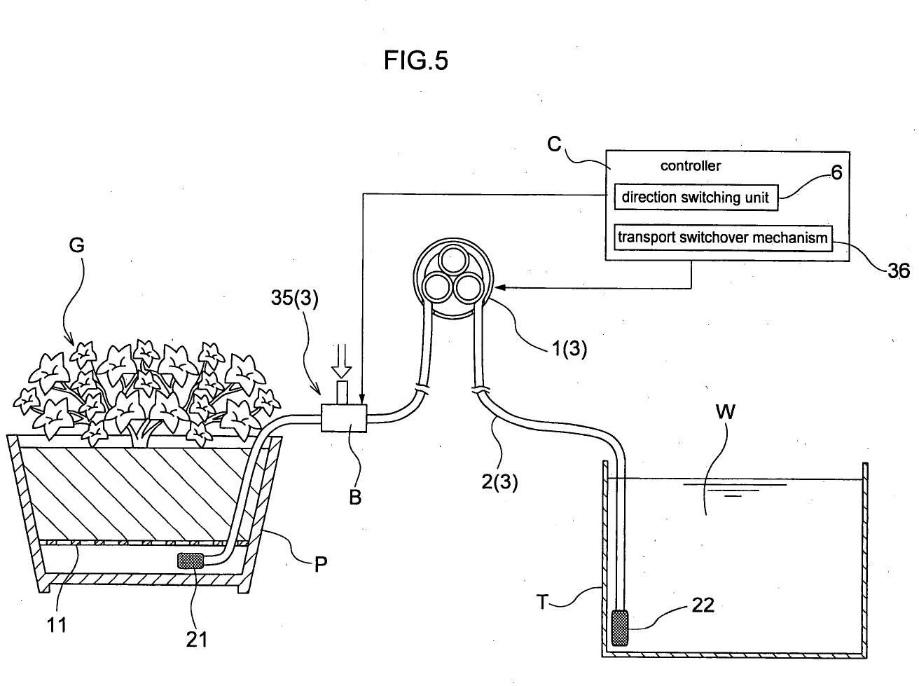

According to the sixth characterizing feature of the plant culturing apparatus relating to the present invention, as exemplarily illustrated in FIG. 5, said transport unit 3 includes an outside air introducing mechanism 35 capable of introducing outside air from an intermediate portion of the feed/discharge tube 2 located between the tube pump 1 and the culture vessel P and transporting the air within the feed/discharge tube 2; and said culturing apparatus further comprises a transport switchover mechanism 36 for causing the outside air introducing mechanism to introduce the outside air from said intermediate portion of the feed/discharge tube after the predetermined amount of the fluid has been transported to the reservoir from the terminal end of the feed/discharge tube connected and communicated with the bottom of the culture vessel to the reservoir.

[Function/Effect]

With this feature, the apparatus can provide even more favorable conditions to the plant growth.

Namely, the transport switchover mechanism 36 can cause the outside air introducing mechanism to introduce the outside air from said intermediate portion of the feed/discharge tube after the predetermined amount of the fluid has been transported to the reservoir from the terminal end of the feed/discharge tube connected and communicated with the bottom of the culture vessel to the reservoir.

With the above, when outside air is introduced from the one end of the feed/discharge tube into the culturing medium, appropriate ventilation can be provided to the medium. For instance, it is possible to prevent excessive supply of outside air into the medium for drying it. Moreover, since the outside air drawn in from the intermediate portion by the outside air introducing mechanism is continuously transported to the reservoir after the switchover to the outside air transport, sufficient aeration can be provided to the fluid reserved in the reservoir, thus increasing the concentration of oxygen dissolved in the fluid.

Consequently, appropriate ventilation can be provided to the medium and sufficient aeration can be provided to the fluid reserved in the reservoir, so that the plant can be cultured under even more favorable conditions.

According to the characterizing feature of a plant culturing method relating to the present invention, as exemplarily illustrated in FIGS. 2(c) and (d), the method comprises the steps of:

discharging a fluid W from a culture vessel P for culturing the plant G to a reservoir T capable of reserving therein the fluid to be fed to the plant by using a transport unit 3 capable of transporting the fluid between the culture vessel and the reserving through a feed/discharge tube 2 connected and communicated with the transport unit via a tube pump 1; and

aerating the fluid W in the reservoir T by feeding air introduced from the culture vessel P to the reservoir T.

[Function/Effect]

First, as a transport unit, the method employs a transport unit having a feed/discharge tube connected and communicated via a tube pump between a culture vessel for culturing a plant and a reservoir capable of reserving a fluid to be fed to the plant. With this, the maintenance operation of the transport unit can be easily done. Further, compared with a vacuum pump or a compressor, the tube pump can be formed compact and also the operating vibrations and noise are smaller. Hence, this can be used in such environment as a porch, sun room of a domestic house or inside a room, without disturbing the environment.

And, by effecting the discharging step of discharging the fluid from the culture vessel to the reservoir by using this transport unit, it is possible to effectively prevent root rot of the plant being cultured due to excessive supply of the fluid to the plant. Also, by introducing fresh air from the outside into the culturing medium in association with the withdrawal of the fluid, the ventilation inside the medium can be promoted. Further, in the aerating step subsequent to this discharging step, the air introduced from the culture vessel is transported to the reservoir, thus providing aeration to the fluid or liquid (e.g. water, nutrient solution, etc.) reserved in the reservoir. Hence, the concentration of oxygen dissolved in the fluid reserved in the reservoir can be increased.

Therefore, the plant can be cultured sufficiently.

Incidentally, although reference marks and numerals are provided in the above discussion for the purpose of facilitating reference to the accompanying drawings, it is understood that the provision of these marks/numerals is not to limit the scope of the present invention to the constructions shown in the drawings.

[FIG. 1]

an explanatory view showing one embodiment of a plant culturing apparatus relating to the present invention,

[FIG. 2]

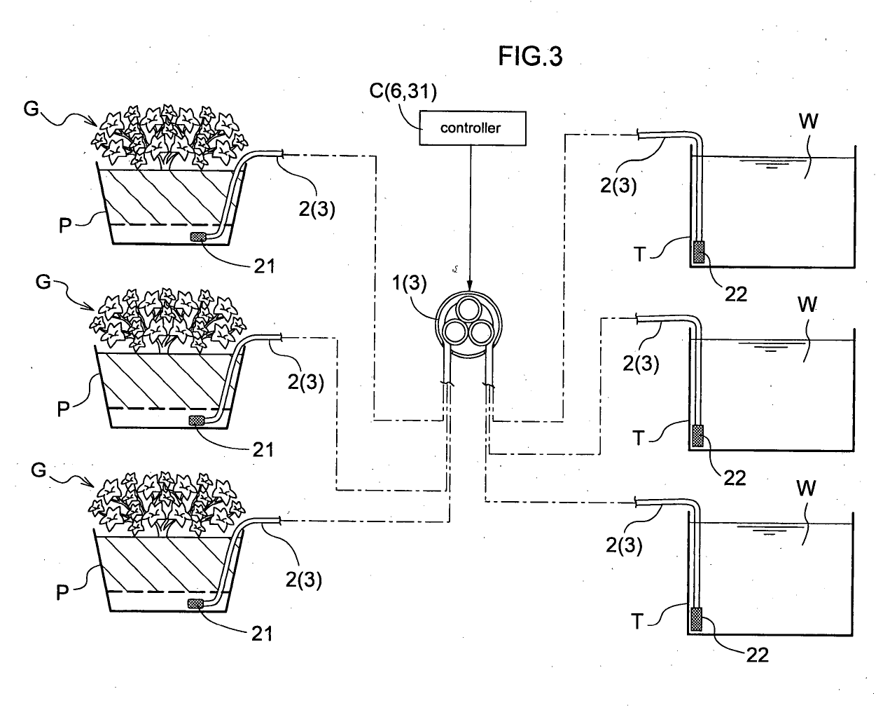

an explanatory view showing one embodiment of a plant culturing method relating to the present invention,

[FIG. 3]

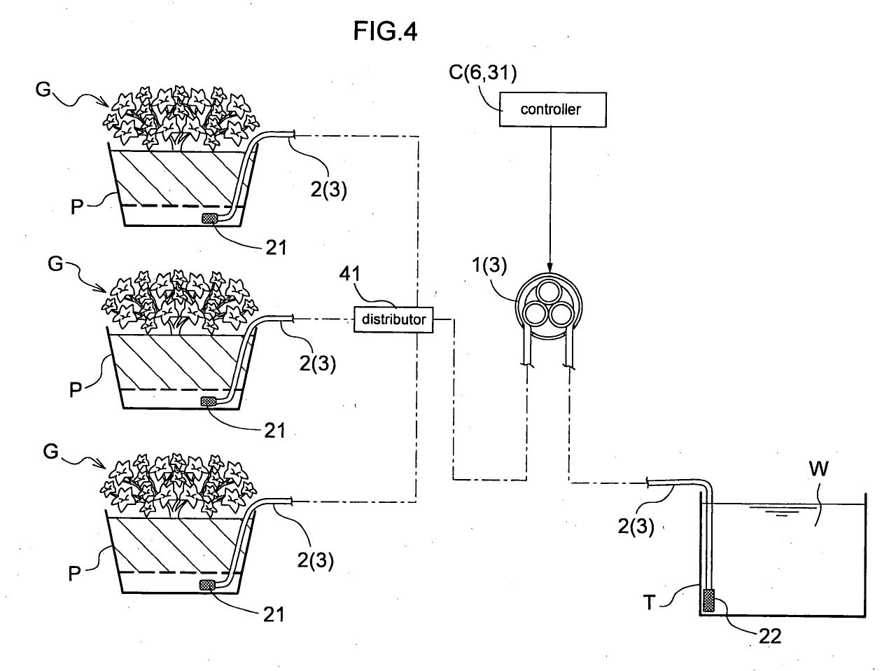

an explanatory view showing a further embodiment of the present invention,

[FIG. 4]

an explanatory view showing a still further embodiment of the present invention,

[FIG. 5]

an explanatory view showing a still further embodiment of the present invention.

### DESCRIPTION OF REFERENCE MARKS

G plant
P culture vessel
T reservoir
W liquid
1 tube pump
2 feed/discharge tube
3 transport unit
6 direction switching unit
31 time control mechanism
35 outdoor air introducing mechanism
36 transport switchover mechanism

### EMBODIMENTS OF THE INVENTION

FIG. 1 shows one preferred embodiment of a plant culturing apparatus relating to the present invention. This plant culturing apparatus includes a culture vessel P for culturing a plant G, a reservoir T capable of reserving a liquid W to be fed to the plant G, a transport unit 3 and a direction switching unit 6. The transport unit 3 is capable of transporting the fluid W between the culture vessel P and the reservoir T through a feed/discharge tube 2 connected and communicated with the transport unit 3 via a tube pump 1. The direction switching unit 6 is capable of switching a transporting direction of the fluid W by the transporting unit 3 between a direction for feeding the fluid W from the reservoir T to the culture vessel P and the opposite direction for discharging the fluid W from the culture vessel P to the reservoir T.

The culture vessel P is for culturing the plant G and is capable of holding therein a medium for culturing the plant G and capable also of reserving the fluid W fed via the feed/discharge tube 2.

A culturing medium held in the culture vessel P can be any medium capable of culturing the plant G. Some non-limiting examples thereof include such commonly employed natural media as compost, leaf mold, peat moss, as well as artificial media such as vermiculite, pearlite, rock wool, hydro ball, sponge, etc.

For instance, as shown in FIG. 1, as a partition 11 permeable to liquid and gas but almost impermeable to solids, a partitioning plate having through holes can be set on the bottom side of the culture vessel P, and the medium is placed upwardly of the partitioning plate 11 and one terminal end of the feed/discharge tube 2 is placed downwardly of the partitioning plate 11. With this arrangement, it becomes possible to reduce the risk of mixing of the medium into the feed/discharge tube 2 when the fluid is transported via the feed/discharge tube 2 as will be described later as well as the further risk of the root of the plant G intruding into the feed/discharge tube 2. Needless to say, the partitioning plate 11 can be formed integral with the culture vessel P or can be provided as a member separate from the vessel P. Further, the partition is not limited the partitioning plate shown in the drawing, but can be any member permeable to the liquid and gas, but hardly permeable to the solids. Examples thereof include a root-preventing sheet, mesh, felt, sponge, etc.

The reservoir T can be formed of any material which is capable of reserving the liquid W to be fed to the plant. Here, the liquid W can be simply water or any water solution of various nutrients (e.g. agents for nutrition, vitalization and germicide useful for the plant).

Further, the tube pump 1 is provided at an intermediate portion of the feed/discharge tube 2 connected and communicated between the culture vessel 2 and the reservoir T. This tube pump 1 can be a commonly available tube pump (called also as “roller pump” or “peristaltic pump”). The “tube pump 1” as used herein refers to a pump constructed such that in association with rotation of a rotor having a plurality of rollers about its periphery along the peripheral direction, the rotating rollers press an elastic feed/discharge tube against the inner wall of a pump head to discharge fluid present inside the feed/discharge tube and in association with elastic resilience of the tube portion pressed by the rollers, a negative pressure is developed inside the tube, which pressure draws in new fluid, so that the pump provides suction and discharge actions by effecting the above operations in series.

The requirement for the feed/discharge tube 2 is its ability to transport the fluid in association with the rotation of the tube pump 1 described above. Therefore, this tube can be formed of any material as long as such material has elasticity and predetermined pressure-resistance. Preferably, the tube has a coloring for preventing alga growth.

Then, this feed/discharge tube 2 is disposed so as to connect and communicate between the culture vessel 2 and the reservoir T. For instance, as shown in FIG. 1, one terminal end of the tube 2 can be connected and communicated with the bottom portion of the culture vessel P and the other terminal end thereof can be connected and communicated with the bottom portion of the reservoir T. And, preferably, at the respective terminal ends of the feed/discharge tube 2, there are provided filters 21, 22 for preventing intrusion of foreign substance such as a root of the plant, the culturing medium, etc. into the feed/discharge tube 2.

What is required for the feed/discharge tube 2 is its ability of connecting/communicating between the culture vessel P and the reservoir T. Hence, this feed/discharge tube 2 can be a single tube, of course, but can also be a plurality of tubes interconnected into a single tube assembly.

In the instant embodiment, there is further provided a controller C for controlling the operation of the tube pump 1, the controller C incorporating therein a direction switching unit 6 and a time controlling mechanism 31.

The direction switching unit 6 switches over the rotational direction of the tube pump 1 between the forward direction and the reverse direction, thereby to switch over the transport direction of the fluid by the transport unit 3 between a direction for feeding the fluid (liquid W) from the reservoir to the culture vessel P and the opposite direction for discharging the fluid (liquid W and outside air) from the culture vessel P to the reservoir T. The unit 6 can comprise a manual switch for controlling the rotation of the tube pump 1 or a timer etc. for automatically controlling the rotation of the pump 1 by a predetermined time interval. In the latter case, the liquid W can be reliably supplied to the plant without fail, hence, advantageous.

As an example of the time controlling mechanism 31, in this embodiment, this mechanism 31 is configured for calculating a transport speed of the fluid (liquid W or outdoor air) based on a rotational time period of the tube pump 1 determined by e.g. a timer and a rotational speed of the pump 1 and then, based thereon, stopping the transportation of the fluid from the terminal end of the feed/discharge tube 2 connected and communicated with the bottom of the culture vessel P to the reservoir T upon lapse of a predetermined time period by stopping the rotation of the tube pump 1. With this, appropriate ventilation is provided to the culturing medium, thus allowing the plant to grow in a more reliable manner. Further, in this embodiment, the mechanism 31 is configured also for terminating the transportation of the fluid from inside the culture vessel P to the reservoir T upon lapse of the predetermined time period after completion of transportation of the fluid from inside of the culture vessel P to the reservoir T and allowing an aerating step to take place subsequently thereto.

Incidentally, the requirement for the time controlling mechanism 31 is its ability to terminate the transportation of the fluid (liquid W or outside air) from the one terminal end of the feed/discharge tube 2 connected and communicated with the bottom of the culture vessel P to the reservoir T upon lapse of a predetermined time period. Further, instead of such time controlling mechanism 31, a controlling mechanism can be provided which terminates the transportation of the fluid (liquid W or outside air) from the one terminal end of the feed/discharge tube 2 connected and communicated with the bottom of the culture vessel P to the reservoir T after transport of the predetermined amount of fluid. For example, the control mechanism can be configured such that the determination of whether a predetermined amount of fluid has been transported or not is made based on the electric conductivity (EC) of the medium, pH of the medium, the transport amount of the liquid or humidity of the medium, etc.

Next, an exemplary use of the plant culturing apparatus having the above-described construction will be described with reference to FIG. 2.

(1) As shown in FIG. 2 (a) and 2 (b), the tube pump 1 is rotated in the forward direction for feeding the liquid W from the reservoir T to the culture vessel P. When a predetermined amount of the liquid has been fed, the rotation of the tube pump 1 is stopped. This is the feeding step. In this, advantageously, the amount of the liquid W fed to the culture vessel P is automatically set by the controller C such that an optimal watering depth may be provided, depending on the type of the plant G to be cultured.

(2) Then, upon lapse of a predetermined time period after completion of feeding of the liquid W to the culture vessel P, the tube pump 1 is rotated in the reverse direction, thereby to discharge the liquid W from the culture vessel P to the reservoir T. This is the discharging step for preventing excessive supply of liquid W, thus preventing root rot of the plant.

(3) Next, after completion of the discharge of the liquid W from the culture vessel P, the tube pump 1 is continued to be driven in the reverse direction, thereby to draw in outside air from the culture vessel P and transport this air to the reservoir T for a predetermined time period. This is the aerating step. With this aerating step, while ventilation is provided to the culturing medium, the concentration of oxygen dissolved in the liquid W reserved in the reservoir T is increased.

With repetition of the above-described operations, the water feeding operation to and water discharging operation form the plant and the aeration of the liquid W can be effected easily and appropriately; and with the repetition of the aeration of the liquid W, the culturing of the plant can be effected easily and appropriately. Incidentally, in the above-described example, the process begins with the step (1) of feeding the liquid to the reservoir. Needless to say, the invention is not limited thereto. The process can begin with the step (2) instead.

As described above, according to the apparatus and the method proposed by the present invention, the water feeding operation, water discharging operation and the aeration operation can be carried out easily and without much noise generation. The invention is advantageous also in that these operations of the water feeding operation, water discharging operation, ventilation within the culture vessel and the aeration operation of the liquid within the reservoir are realized by a single feed/discharge tube with simple change over of the rotational direction of the tube pump.

### Other Embodiments

Next, other embodiments of the invention will be described.

<1> In the foregoing embodiment, the tube pump 1 is connected with a single feed/discharge tube 2. Instead, depending on the capacity of the tube pump 1, a plurality of feed/discharge tubes 2 may be connected thereto. For instance, as shown in FIG. 3, in the case, the tube pump 1 can include three heads which are connected respectively to the plurality of feed/discharge tubes 2 connected and communicated between the culture vessel P and the reservoir T.

<2> FIG. 4 shows a further modified arrangement. In this case, there is provided a single feed/discharge tube 2 for connection and communication between the culture vessel P and the reservoir T. And, at a portion of this tube located between the tube pump 1 and the culture vessel P, the tube is branched by a distributor 41 into a plurality of tube segments which are connected respectively to a plurality of culture vessels P for feeding the liquid to these plural vessels P.

<3> FIG. 5 shows a still further modified arrangement. In this case, the transport unit 3 includes an outside air introducing mechanism 35 capable of introducing outside air from an intermediate portion of the feed/discharge tube 2 located between the tube pump 1 and the culture vessel P and transporting this air within the feed/discharge tube 2. And there is provided a transport switchover mechanism 36 for causing the outside air introducing mechanism to introduce the outside air from said intermediate portion of the feed/discharge tube 2 after the fluid has been transported to the reservoir T from the terminal end of the feed/discharge tube 2 connected and communicated with the bottom of the culture vessel P to the reservoir T has been effected for a predetermined time period. In the case of the construction shown in FIG. 5, at an intermediate portion of the feed/discharge tube 2 located between the tube pump 1 and the culture vessel P, there is provided a branching valve (e.g. an electromagnetic valve) B for branching the feed/discharge tube on the side of the culture vessel P. The controller C includes the transport switchover mechanism 36 for switching over, by switching of the branching valve B, between transport to the reservoir T from the end of the feed/discharge tube 2 connected and communicated with the culture vessel P and the transport of introducing outside air from the intermediate portion to the reservoir T. Hence, sufficient aeration is provided to the liquid reserved in the reservoir while appropriate ventilation is provided to the culturing medium.

<4> In the foregoing embodiments, one end of the feed/discharge tube 2 is connected and communicated with the bottom of the culture vessel. The invention is not limited thereto. Instead, for instance, one terminal end of the feed/discharge tube 2 may be disposed at the upper portion of the culture vessel or at a position above the vessel, depending on the type of plant to be cultured.

### EXAMPLE

Next, a specific example will be described. In, this as the culture vessel, there was employed a hanging pot made of plastics (diameter: 270 mm, depth: 200 mm). The water drain opening formed in its bottom was closed and a catch basin provided as an accessory was set therein and a root-preventing sheet was also placed therein. An air-stone filter was attached to one terminal end of an urethane tube (outer diameter: 8 mm, inner diameter: 6 mm) as an example of the feed/discharge tube, and this air-stone filter was set at a lowest position possible at the bottom of the pot downwardly of the catch basin. The other end of the urethane tube was drawn from the upper portion of the hanging pot and connected via a joint to an inner-pump tube (corresponding to the “feed/discharge tube”) extending to a tube pump located about 5 meters away. As this inner-pump tube, there was employed about 10 cm length of a pressure-resistant tube (outer diameter: 8 mm, inner diameter: 5 mm) for use with a roller pump and this tube was extended to a nutrient liquid tank (polyethylene tank of 20 liter capacity) as an example of reservoir located about 1 meter away. Incidentally, to the leading end of the urethane tube, an air-stone filter was attached and this was set at the bottom of the nutrient liquid tank.

Then, rock wool was charged into the hanging pot, in which three stubs of petunia were planted and then hung. A forward-rotation power input terminal and a reverse-rotation power input terminal of the tube pump were connected respectively to a timer and this timer was set to a schedule shown in Table 1 for forward rotation (liquid feeding) and reverse rotation (liquid discharge and aeration).

TABLE 1

| rotational | | | | | | |
|---|---|---|---|---|---|---|
| direction | | | | | | |
| of pump | time (hour) | | | | | |
| forward | 7:00 | 10:00 | 13:00 | 16:00 | 19:00 | 22:00 |
| (liquid | | | | | | |
| feed) | | | | | | |
| reverse | 8:00 | 11:00 | 14:00 | 17:00 | 20:00 | 23:00 |
| (liquid | | | | | | |
| discharge, | | | | | | |
| aeration | | | | | | |

Note:
each operation is effected for 3 minutes

The rotational speed of the pump was about 160 rpm, with which about 500 cc of liquid was fed each time. During the reverse rotation, about 2 minutes of liquid discharge and about 1 minute of aeration of nutrient liquid in the nutrient liquid tank were carried out. The aeration could be confirmed by bubbles in the nutrient liquid tank. Incidentally, the liquid discharge time period and the liquid discharge amount can be adjusted variably since they differ depending on the culturing temperature, humidity and the degree of plant growth.

The nutrient liquid reserved and charged inside the nutrient liquid tank was about 1000 times dilution of a commercially available liquid nutrient. (EC=1˜2 is preferred). Incidentally, if a slow-release solid nutrient is charged in the hanging pot, water can be reserved in the nutrient liquid tank.

Under the above-described conditions, the culture was initiated. And, every 10 days or every 2 weeks, the nutrient liquid in the tank was replenished. Without any other caring operations than the above, petunia with many flowers were grown to the height of about 1 meter after one month and about 2 meters after 3 months, respectively.

1. A plant culturing apparatus comprising:
a transport unit capable of transporting a fluid between a culture vessel for culturing a plant and a reservoir capable of reserving therein the fluid to be fed to the plant through a feed/discharge tube connected and communicated with the transport unit via a tube pump; and
a direction switching unit capable of switching a transporting direction of the fluid by the transporting unit between a direction for feeding the fluid from the reservoir to the culture vessel and the opposite direction for discharging the fluid from the culture vessel to the reservoir.

2. The plant culturing apparatus according to claim 1, wherein one terminal end of said feed/discharge tube is connected and communicated with a bottom of the culture vessel.

3. The plant culturing apparatus according to claim 2, further comprising a control mechanism for terminating the transport of the fluid from the one terminal end of the feed/discharge tube connected and communicated with the bottom of the culture vessel to the reservoir after a predetermined amount of the fluid has been transported to the reservoir.

4. The plant culturing apparatus according to claim 3, wherein said control mechanism comprises a time control mechanism for controlling said transport unit according to an operational time period of the transport unit.

5. The plant culturing apparatus according to claim 4, wherein said operational time period of the transport unit is set longer than a time period within which the transport of the fluid from inside the culture vessel to the reservoir is terminated.

6. The plant culturing apparatus according to claim 2, wherein said transport unit includes an outside air introducing mechanism capable of introducing outside air from an intermediate portion of the feed/discharge tube located between the tube pump and the culture vessel and transporting the air within the feed/discharge tube; and
said culturing apparatus further comprises a transport switchover mechanism for causing the outside air introducing mechanism to introduce the outside air from said intermediate portion of the feed/discharge tube to the reservoir after the predetermined amount of the fluid has been transported to the reservoir from the terminal end of the feed/discharge tube connected and communicated with the bottom of the culture vessel to the reservoir.

7. A method for culturing a plant, comprising the steps of:
discharging a fluid from a culture vessel for culturing the plant to a reservoir capable of reserving therein the fluid to be fed to the plant by using a transport unit capable of transporting the fluid between the culture vessel and the reservoir through a feed/discharge tube connected and communicated with the transport unit via a tube pump; and
aerating the fluid in the reservoir by feeding air introduced from the culture vessel to the reservoir.
